(19) United States
(12) Patent Application Publication
(10) Pub. No.: US 2025/0175313 A1
(43) Pub. Date: May 29, 2025

(54) SUB-BAND FULL DUPLEX FOR MULTIPLE TRANSMISSION RECEPTION POINT TRANSMISSION SCHEMES

(71) Applicant: QUALCOMM Incorporated, San Diego, CA (US)

(72) Inventors: Muhammad Sayed Khairy ABDELGHAFFAR, San Jose, CA (US); Mostafa KHOSHNEVISAN, San Diego, CA (US); Abdelrahman Mohamed Ahmed Mohamed IBRAHIM, San Diego, CA (US); Ahmed Attia ABOTABL, San Diego, CA (US)

(21) Appl. No.: 18/520,424

(22) Filed: Nov. 27, 2023

(51) Int. Cl. H04L 5/14; H04L 5/00; H04W 72/1268; H04W 72/21

(52) U.S. Cl. CPC H04L 5/14; H04L 5/0051; H04W 72/1268; H04W 72/21

(57) ABSTRACT

Various aspects of the present disclosure generally relate to wireless communication. Some aspects relate to multiple transmission reception point (mTRP) transmission in the context of sub-band full duplex (SBFD) communication and non-SBFD communication. In some aspects, a user equipment (UE) may use an uplink mTRP transmission scheme on both SBFD resources and non-SBFD resources. For example, the UE may use the same transmission parameters for SBFD and non-SBFD resources, or may use different transmission parameters for SBFD and non-SBFD resources. In some other aspects, a UE may perform mTRP transmission only on non-SBFD resources, and may switch to sTRP transmission on SBFD resources. In some aspects, the UE may perform mTRP transmission in SBFD resources, or may fall back to sTRP transmission in SBFD resources, according to an indication of whether to perform mTRP transmission in SBFD resources.

### FIELD OF THE DISCLOSURE

Aspects of the present disclosure generally relate to wireless communication and specifically relate to techniques, apparatuses, and methods for sub-band full duplex for multiple transmission reception point transmission schemes.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

A network node, such as a gNB of a radio access network (RAN), may be associated with a number of transmission reception points (TRPs). Each TRP may transmit and/or receive communications associated with the gNB. In some examples, a user equipment (UE) may communicate with multiple TRPs, such as at the same time or in different time resources. This may be referred to as multiple TRP (mTRP) communication, and may include an uplink mTRP transmission scheme. In an uplink mTRP transmission scheme, a UE may transmit a communication (such as different parts of a communication, redundant versions of the same communication, or the like) to multiple TRPs, which improves reliability of the communication by increasing diversity of transmission.

Communications in a RAN may be half-duplex communications or full-duplex communications. Generally, in half-duplex communication, a given bandwidth is utilized for only one direction of communication (such as uplink or downlink, or transmission or reception) at a given time. In full-duplex communication, a given bandwidth is utilized concurrently for two directions of communication. Full-duplex communication can include in-band full-duplex (IBFD), in which uplink and downlink communications are overlapped in both time and frequency. Full-duplex communication can also include sub-band full duplex (SBFD). In SBFD, a bandwidth, such as a component carrier, is divided into two or more sub-bands. Each sub-band is configured for uplink or downlink communication, and may be separated from other sub-bands by a guard band. A UE may be configured with a set of resources for uplink mTRP transmission. In some examples, this set of resources may overlap with one or more resources configured as SBFD resources. Thus, a set of resources for uplink mTRP transmission may include one or more SBFD resources and one or more non-SBFD resources.

### SUMMARY

In some aspects, an apparatus for wireless communication at a user equipment (UE) includes one or more memories storing processor-executable code; and one or more processors coupled with the one or more memories, at least one processor of the one or more processors configured to cause the UE to: receive a configuration of an uplink multiple transmission reception point (TRP) (mTRP) transmission scheme for a first set of resources; receive an indication of a sub-band full duplex (SBFD) configuration relating to a second set of resources, the first set of resources including at least one resource of the second set of resources, wherein the at least one resource is at least one SBFD resource; and transmit a communication in accordance with the uplink mTRP transmission scheme on a subset of resources of the first set of resources, the subset of resources being derived from the SBFD configuration.

In some aspects, an apparatus for wireless communication at a network node includes one or more memories storing processor-executable code; and one or more processors coupled with the one or more memories, at least one processor of the one or more processors configured to cause the network node to: transmit a configuration of an uplink multiple transmission reception point (TRP) (mTRP) transmission scheme for a first set of resources; transmit an indication of a sub-band full duplex (SBFD) configuration relating to a second set of resources, the first set of resources including at least one resource of the second set of resources, wherein the at least one resource is at least one SBFD resource; and receive a communication in accordance with the uplink mTRP transmission scheme on a subset of resources of the first set of resources, the subset of resources being derived from the SBFD configuration.

In some aspects, a non-transitory computer-readable medium storing a set of instructions for wireless communication includes one or more instructions that, when executed by one or more processors of a user equipment (UE), cause the UE to: receive a configuration of an uplink multiple transmission reception point (TRP) (mTRP) transmission scheme for a first set of resources; receive an indication of a sub-band full duplex (SBFD) configuration relating to a second set of resources, the first set of resources including at least one resource of the second set of resources, wherein the at least one resource is at least one SBFD resource; and transmit a communication in accordance with the uplink mTRP transmission scheme on a subset of resources of the first set of resources, the subset of resources being derived from the SBFD configuration.

In some aspects, a non-transitory computer-readable medium storing a set of instructions for wireless communication includes one or more instructions that, when executed by one or more processors of a network node, cause the network node to: transmit a configuration of an uplink multiple transmission reception point (TRP) (mTRP) transmission scheme for a first set of resources; transmit an indication of a sub-band full duplex (SBFD) configuration relating to a second set of resources, the first set of resources including at least one resource of the second set of resources, wherein the at least one resource is at least one SBFD resource; and receive a communication in accordance with the uplink mTRP transmission scheme on a subset of resources of the first set of resources, the subset of resources being derived from the SBFD configuration.

In some aspects, an apparatus for wireless communication includes means for receiving a configuration of an uplink multiple transmission reception point (TRP) (mTRP) transmission scheme for a first set of resources; means for receiving an indication of a sub-band full duplex (SBFD) configuration relating to a second set of resources, the first set of resources including at least one resource of the second set of resources, wherein the at least one resource is at least one SBFD resource; and means for transmitting a communication in accordance with the uplink mTRP transmission scheme on a subset of resources of the first set of resources, the subset of resources being derived from the SBFD configuration.

In some aspects, an apparatus for wireless communication includes means for transmitting a configuration of an uplink multiple transmission reception point (TRP) (mTRP) transmission scheme for a first set of resources; means for transmitting an indication of a sub-band full duplex (SBFD) configuration relating to a second set of resources, the first set of resources including at least one resource of the second set of resources, wherein the at least one resource is at least one SBFD resource; and means for receiving a communication in accordance with the uplink mTRP transmission scheme on a subset of resources of the first set of resources, the subset of resources being derived from the SBFD configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network in accordance with the present disclosure.

FIG. 3 is a diagram illustrating an example of SBFD schemes for mTRP communication.

FIG. 4 is a diagram examples of mTRP and single TRP (sTRP) communication in SBFD resources and non-SBFD resources.

FIG. 5 is a diagram illustrating an example of signaling relating to mTRP configuration in conjunction with SBFD resources.

FIG. 6 is a flowchart illustrating an example process performed, for example, at a UE or an apparatus of a UE that supports mTRP transmission for SBFD in accordance with the present disclosure.

FIG. 7 is a flowchart illustrating an example process performed, for example, at a network node or an apparatus of a network node that supports mTRP transmission for SBFD in accordance with the present disclosure.

FIG. 8 is a diagram of an example apparatus for wireless communication that supports mTRP transmission for SBFD in accordance with the present disclosure.

FIG. 9 is a diagram of another example apparatus for wireless communication that supports mTRP transmission in SBFD in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As mentioned, a UE may communicate in accordance with an uplink multiple transmission reception point (mTRP) transmission scheme. In an uplink mTRP transmission scheme, a UE may transmit a communication (such as different parts of a communication, redundant versions of the same communication, or the like) to multiple TRPs, which improves reliability of the communication by increasing diversity of transmission.

As also mentioned, communications in a RAN may be performed in full-duplex, such as sub-band full duplex (SBFD). SBFD may be implemented on an SBFD resource, such as a slot or symbol, that includes two or more sub-bands. SBFD can improve the efficiency of bandwidth utilization, and may facilitate communication by an SBFD-capable node with multiple other wireless communication devices concurrently. For example, the SBFD-capable node may use a first sub-band for communication with a first UE, and may use a second sub-band for communication with a second UE. In some examples, half-duplex communication may be configured via a time division duplexing (TDD) configuration, in which each resource of a set of resources is configured as an uplink resource, a downlink resource, or a flexible resource.

A UE may be configured with a set of resources for uplink mTRP transmission, such as by downlink control information scheduling an mTRP transmission or a medium access control (MAC) control element (MAC-CE) activating certain beams for an mTRP transmission. In some examples, this set of resources may overlap with one or more resources configured as SBFD resources. Thus, a set of resources for uplink mTRP transmission may include one or more SBFD resources and one or more non-SBFD resources. Various difficulties may arise in such a situation. For example, it may be unclear whether the UE should continue with mTRP transmission in the SBFD resource, or should “fall back” to single TRP (sTRP) transmission. mTRP transmission may increase bandwidth and reliability but may exceed capabilities of some UEs. STRP transmission may conserve resources of the UE while providing lower bandwidth and reliability. Furthermore, there may be situations where it is more beneficial to continue with mTRP transmission, and other situations where it is more beneficial to fall back to sTRP transmission in an SBFD resource. A fixed approach of always switching to mTRP or always falling back to sTRP transmission may be suboptimal in some situations.

Still further, performing mTRP transmission across SBFD resources and non-SBFD resources may involve a larger number of active TRPs than mTRP transmission in a single type of resource. Some forms of signaling of transmission parameters (for example, transmission configuration indicator states or the like) may not accommodate this larger number of active TRPs.

Furthermore, a UE may perform beam switching (such as TRP switching) according to a beam pattern that indicates a sequence or cycle of beams for repetitions of a communication. Ambiguity may arise in the application of a beam pattern for mTRP transmissions spanning SBFD and non-SBFD resources, such as whether a same beam pattern should be used for SBFD resources and for non-SBFD resources. As another example, a beam pattern configured for mTRP communication may be unsuitable for sTRP communication in a case where a UE falls back to sTRP communication in an SBFD resource.

Aspects of the present disclosure relate generally to mTRP transmission in the context of SBFD communication. Some aspects more specifically relate to mTRP/sTRP transmission on resources including both SBFD resources and non-SBFD resources. In some aspects, a UE may use an uplink mTRP transmission scheme on both SBFD resources and non-SBFD resources. An uplink mTRP transmission scheme may schedule or configure mTRP transmission on a set of resources (which may include SBFD and non-SBFD resources). For example, the UE may use the same transmission parameters for SBFD and non-SBFD resources, or may use different transmission parameters for SBFD and non-SBFD resources. In some other aspects, a UE may perform mTRP transmission only on non-SBFD resources, and may switch to sTRP transmission on SBFD resources. In some aspects, the UE may perform mTRP transmission in SBFD resources, or may fall back to sTRP transmission in SBFD resources, according to an indication of whether to perform mTRP transmission in SBFD resources. For example, the indication may be explicit, or may be implicit in other configurations.

Some aspects of the disclosure provide an indication of transmission parameters for multiple TRPs, such as to support switching TRPs for mTRP transmission in SBFD and non-SBFD resources, or to support communication with a first number of TRPs in a non-SBFD resource falling back to a different TRP in a non-SBFD resource. For example, the indication of the transmission parameters may be via downlink control information (DCI), a MAC-CE, or sounding reference signal (SRS) resource set configurations that are configured to indicate transmission parameters for each of the multiple (such as more than two) TRPs.

Some aspects of the present disclosure provide configuration of beam patterns for mTRP or sTRP communication in SBFD symbols. A beam pattern may indicate how the UE is to switch beams for repetitious transmission of a communication in a time division multiplexing (TDM) manner. For example, some aspects provide for different beam patterns to be configured in SBFD symbols and in non-SBFD symbols. As another example, some aspects provide for a same beam pattern to be used across SBFD symbols and non-SBFD symbols. As yet another example, some aspects provide adaptation of an mTRP beam pattern for sTRP transmission, such as when the UE falls back from transmitting using the mTRP beam pattern in a non-SBFD slot to sTRP transmission in an SBFD slot.

Some aspects of the present disclosure provide channel state information (CSI) multiplexing on multiple physical uplink shared channel (PUSCH) repetitions across SBFD resources and non-SBFD resources in mTRP transmission. Some aspects provide redundancy version sequence handling across SBFD resources and non-SBFD resources in mTRP transmission. For example, the UE may reset a redundancy version sequence at a transition from SBFD resource to non-SBFD resource, or at a transition from non-SBFD resource to SBFD resource.

Aspects of the present disclosure may be used to realize one or more of the following potential advantages. In some aspects, by using an uplink mTRP transmission scheme on both SBFD resources and non-SBFD resources, the UE may increase bandwidth and reliability of uplink communications. By using the same transmission parameters for SBFD and non-SBFD resources, the UE may reduce signaling overhead and complexity of configuration. By using different transmission parameters for SBFD and non-SBFD resources, the UE may increase diversity of communications across SBFD resources and non-SBFD resources. By performing mTRP transmission only on non-SBFD resources, and switching to sTRP transmission on SBFD resources, the UE may simplify implementation of SBFD communication and reduce complexity at the UE. The indication of whether or not to perform mTRP transmission in SBFD resources may enable adaptation to different situations and selection of an optimal approach (such as mTRP transmission or sTRP transmission in SBFD resources) for the different situations.

The indication of transmission parameters for multiple (for example, more than two) TRPs may increase frequency or spatial diversity of uplink communication for mTRP communication and sTRP communication in SBFD resources. Using different beam patterns in SBFD symbols and in non-SBFD symbols may improve adaptability for different TRP combinations, whereas using the same beam pattern across SBFD symbols and non-SBFD symbols may reduce configuration complexity. By adapting an mTRP beam pattern for sTRP transmission, configuration overhead is reduced relative to explicitly configuring a separate beam pattern for sTRP transmission.

CSI multiplexing on multiple PUSCH repetitions across SBFD resources and non-SBFD resources in mTRP transmission may increase spatial diversity (for more than two TRPs), frequency diversity (such as by using different frequency resources in SBFD resources and non-SBFD resources), and/or interference/channel diversity in SBFD and non-SBFD signals. Resetting a redundancy version sequence at a transition from SBFD resource to non-SBFD resource, or at a transition from non-SBFD resource to SBFD resource, may improve reliability and diversity of repetition.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

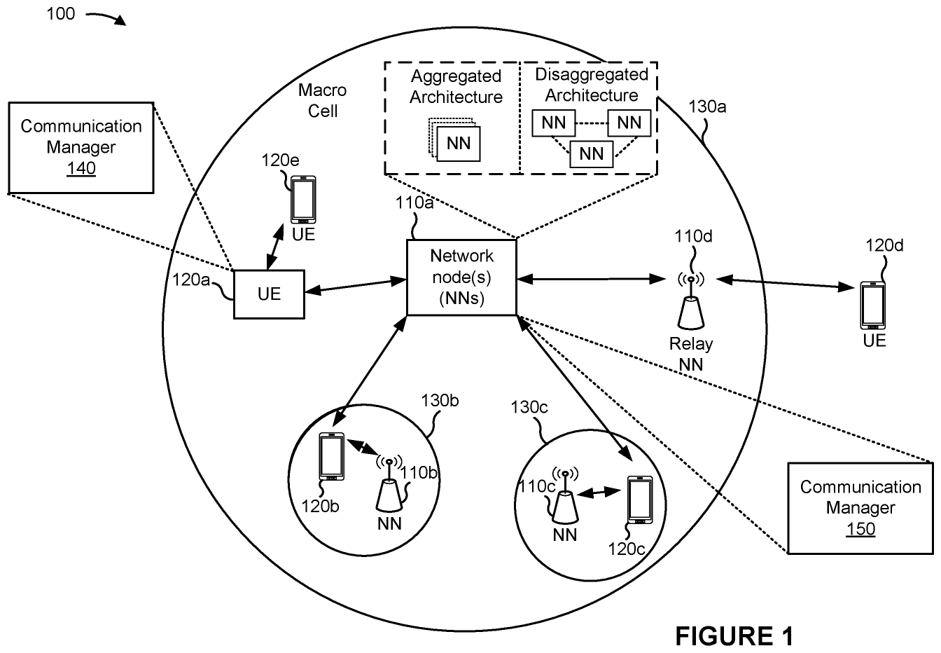

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHZ through 24.25 GHZ), FR4a or FR4-1 (52.6 GHz through 71 GHZ), FR4 (52.6 GHZ through 114.25 GHz), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some implementations, one or more of the multiple memories may be configured to store processor-executable code that, when executed, may configure the one or more processors to perform various functions described herein (as part of a processing system). In some other implementations, the processing system may be pre-configured to perform various functions described herein.

In some examples, a UE 120 may transmit concurrently to multiple TRPs, referred to as multiple TRP (mTRP) uplink communication. mTRP uplink communication may enhance reliability (such as by using uplink time division multiplexing (TDM) with two beams and two power control parameters, or by using a single-frequency network (SFN) approach) and capacity (such as using spatial division multiplexing (SDM) via transmission configuration indicator (TCI) states). In some examples, a single DCI may provide parameters for all TRPs of the mTRP uplink communication.

The network node 110 may provide the UE 120 with a configuration of TCI states that indicate or correspond to beams that may be used by the UE 120, such as for receiving one or more communications via a physical channel. For example, the network node 110 may indicate (for example, using DCI) an activated TCI state to the UE 120, which the UE 120 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or a sounding reference signal (SRS) set ID, among other examples. A TCI state information element (sometimes referred to as a TCI state herein) may indicate particular information associated with a beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-ResourceId or an SSB-Index, among other examples). Spatial relation information may similarly indicate information associated with an uplink beam. The beam indication may be a joint or separate DL/UL beam indication in a unified TCI framework. In a unified TCI framework, a network node 110 may support common TCI state ID update and activation, which may provide common QCL and/or common UL transmission spatial filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some examples, the network may support a layer 1 (L1)-based beam indication using at least UE-specific (unicast) DCI to indicate joint or separate DL/UL beam indications that may be selected from active TCI states. In some examples, DCI formats 1_1 and/or 1_2 may be used for beam indication. The network node 110 may include a support mechanism for the UE 120 to acknowledge successful decoding of a beam indication. For example, the acknowledgment/negative acknowledgment of the physical downlink shared channel scheduled by the DCI carrying the beam indication may also be used as an acknowledgement for the DCI.

In some aspects, the UE 120 may include a communication manager 140. As described in more detail elsewhere herein, the communication manager 140 may receive a configuration of an uplink mTRP transmission scheme for a first set of resources; receive an indication of an SBFD configuration relating to a second set of SBFD resources, the first set of resources including at least one SBFD resource of the second set of SBFD resources; and transmit a communication in accordance with the uplink mTRP transmission scheme on a subset of resources of the first set of resources, the subset of resources being derived from the SBFD configuration. Additionally, or alternatively, the communication manager 140 may perform one or more other operations described herein.

In some aspects, the network node 110 may include a communication manager 150. As described in more detail elsewhere herein, the communication manager 150 may transmit a configuration of an uplink mTRP transmission scheme for a first set of resources; transmit an indication of an SBFD configuration relating to a second set of SBFD resources, the first set of resources including at least one SBFD resource of the second set of SBFD resources; and receive a communication in accordance with the uplink mTRP transmission scheme on a subset of resources of the first set of resources, the subset of resources being derived from the SBFD configuration. Additionally, or alternatively, the communication manager 150 may perform one or more other operations described herein.

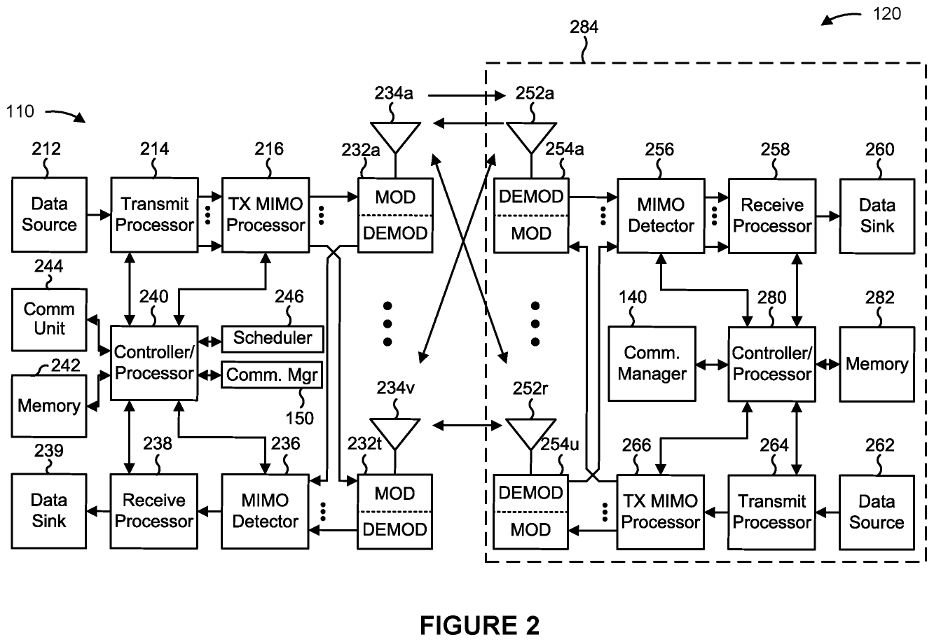

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information communication, a MAC-CE communication, an RRC communication, or another type of uplink communication. Uplink signals may be transmitted on a PUSCH, a physical uplink control channel (PUCCH), and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

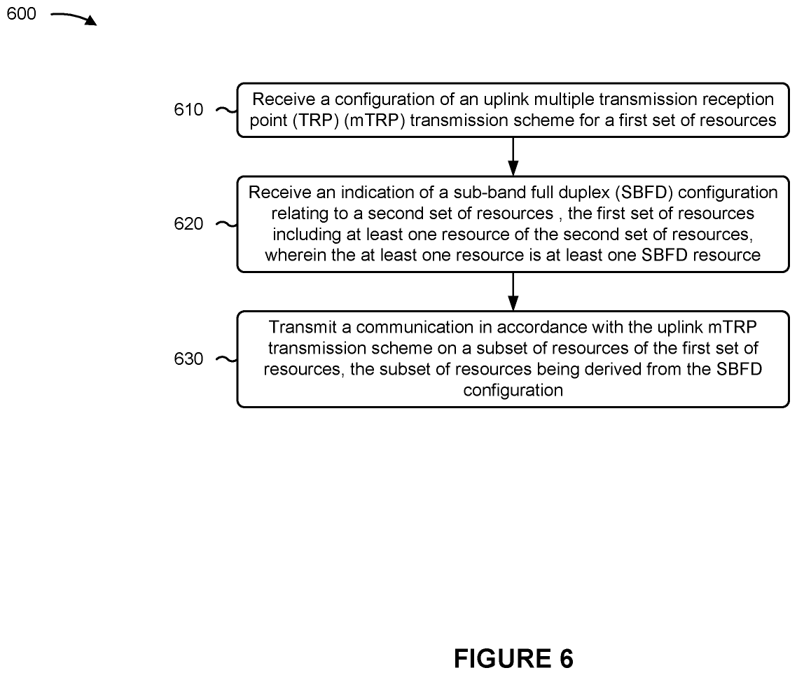

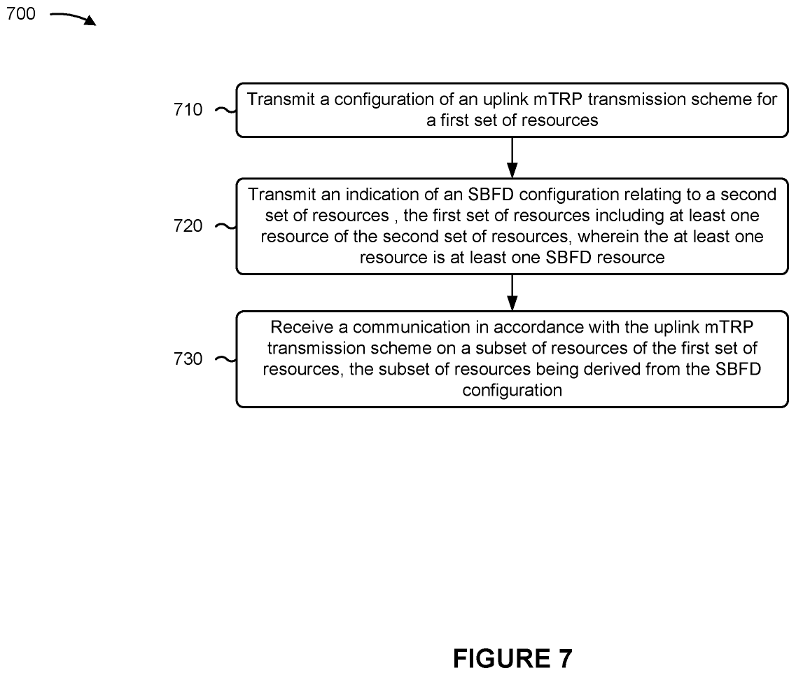

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with mTRP transmission in SBFD, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 600 of FIG. 6, process 700 of FIG. 7, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

In some aspects, the UE 120 includes means for receiving a configuration of an uplink mTRP transmission scheme for a first set of resources; means for receiving an indication of an SBFD configuration relating to a second set of SBFD resources, the first set of resources including at least one SBFD resource of the second set of SBFD resources; and/or means for transmitting a communication in accordance with the uplink mTRP transmission scheme on a subset of resources of the first set of resources, the subset of resources being derived from the SBFD configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a configuration of an uplink mTRP transmission scheme for a first set of resources; means for transmitting an indication of an SBFD configuration relating to a second set of SBFD resources, the first set of resources including at least one SBFD resource of the second set of SBFD resources; and/or means for receiving a communication in accordance with the uplink mTRP transmission scheme on a subset of resources of the first set of resources, the subset of resources being derived from the SBFD configuration. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

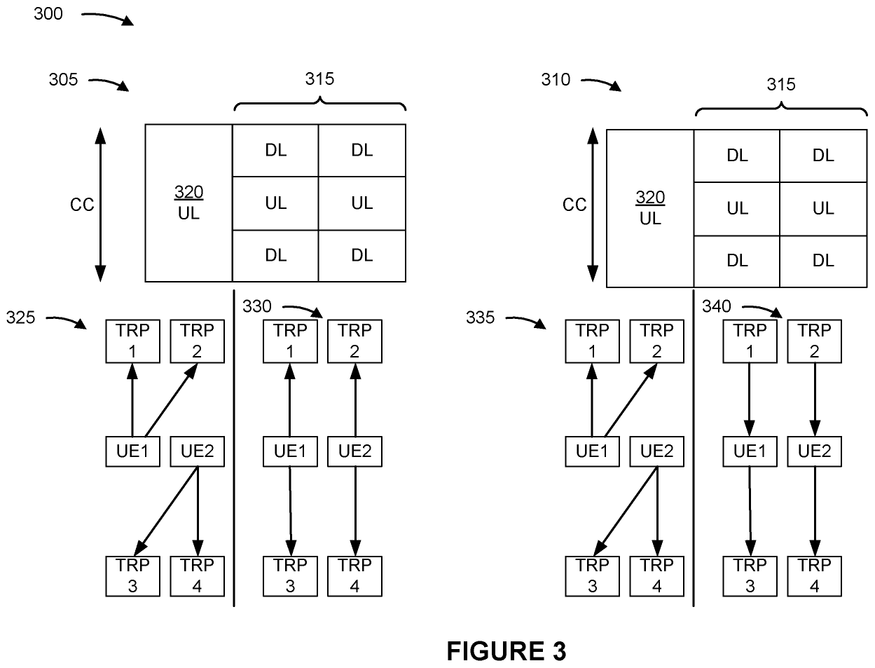

FIG. 3 is a diagram illustrating an example 300 of SBFD schemes for mTRP communication. Example 300 shows a number of TRPs (described in more detail below). The TRPs, or antenna panels of the TRPs, may be spatially separated from one another. For example, spatial isolation between antenna panels, such as transmitting and receiving panels of one or more TRPs, may enable full-duplex communication, such as SBFD communication, at a gNB. Using two TRPs, of a gNB, that are spatially separated may provide isolation between transmissions and receptions of the gNB. This may reduce reliance on an electromagnetic absorber (isolator), which may simplify SBFD communication using existing deployment. Thus, self-interference at a given TRP is reduced, and pathloss can provide sufficient isolation to handle inter-TRP interference. In some deployments, all co-sited sectors may have a same direction during SBFD to mitigate impact of co-site interference.

Example 300 illustrates a first scheme 305 and a second scheme 310. Both the first scheme 305 and the second scheme 310 use a set of resources within a component carrier (CC) such as a time division duplexing (TDD) CC. The set of resources may include SBFD resources 315 and non-SBFD resources 320. An SBFD resource 315 is a resource in which the CC's bandwidth is divided into non-overlapping UL and DL subbands. These subbands may be separated from one another by frequency-domain guard bands, in some instances. In a non-SBFD resource 320, the CC's bandwidth is configured entirely for a single resource type (uplink, downlink, or flexible), such as by a TDD configuration. For the purposes of the description herein, non-SBFD resources are typically uplink or flexible resources.

A TDD configuration may include a cell-common TDD configuration or a dedicated TDD configuration. A TDD configuration may be semi-statically configured via RRC signaling. A cell-common TDD configuration may be provided via an RRC parameter tdd-UL-DL-ConfigurationCommon, and may apply to all UEs associated with a cell. A dedicated TDD configuration may be provided via an RRC parameter tdd-UL-DL-ConfigurationDedicated and may apply to a UE to which the dedicated TDD configuration is directed. A resource can also be semi-statically configured as a flexible resource (for example, having a flexible resource type), referred to herein as an RRC-F resource. After configuration as a semi-statically configured resource, a flexible resource (for example, RRC-F), such as a symbol of a slot, can be subsequently indicated as an uplink resource (for example, a resource having an uplink resource type), a downlink resource (for example, a resource having a downlink resource type), or a flexible resource by a slot format indicator (SFI). An SFI includes an index into a table that identifies how each symbol number in a slot should be configured (for example, as an uplink resource, a downlink resource, or a flexible resource). A flexible resource indicated by an SFI as an uplink resource (for example, as having an uplink resource type) is referred to as an SFI-U resource. A flexible resource indicated by an SFI as a downlink resource (for example, as having a downlink resource type) is referred to as an SFI-D resource. A flexible resource indicated by an SFI as a flexible resource is referred to as an SFI-F resource. An SFI-D resource (or more generally, a resource having a downlink resource type) may have a downlink direction. An SFI-U resource (or more generally, a resource having an uplink resource type) may have an uplink direction.

As shown, the first scheme 305 and the second scheme 310 each involve four TRPs, labeled as TRP1, TRP2, TRP3, and TRP4. Furthermore, the first scheme 305 and the second scheme 310 each involve two UEs, labeled as UE1 and UE2. Uplink communications are indicated by an arrow from a UE to a corresponding TRP, and downlink communications are indicated by an arrow from the corresponding TRP to the UE.

As shown by reference number 325 in the first scheme 305, in a non-SBFD resource 320, UE1 may perform uplink communication with TRPs 1 and 2. UE2 may perform uplink communication with TRPs 3 and 4. Each UE may perform mTRP uplink communication with the TRPs. As shown by reference number 330 in the first scheme 305, in an SBFD resource 315, UE1 may perform uplink communication with TRPs 1 and 3, and UE2 may perform downlink communication with TRP2 and TRP4.

As shown by reference number 335 in the second scheme 310, in a non-SBFD resource 320, UE1 may perform uplink communication with TRPs 1 and 2. UE2 may perform uplink communication with TRPs 3 and 4. Each UE may perform mTRP uplink communication with the TRPs. As shown by reference number 340 in the second scheme 310, in an SBFD resource 315, UE1 may perform downlink communication with TRP1 and uplink communication with TRP3, and UE2 may perform downlink communication with TRP2 and uplink communication with TRP4.

The time resources of FIG. 3 may include slots, subslots, symbols, or the like.

The set of resources of FIG. 3 may belong to a first set of resources configured for mTRP communication. A UE may also be configured with a set of SBFD resources (such as SBFD resource 315). One or more SBFD resources of the set of SBFD resources may be included in the first set of resources.

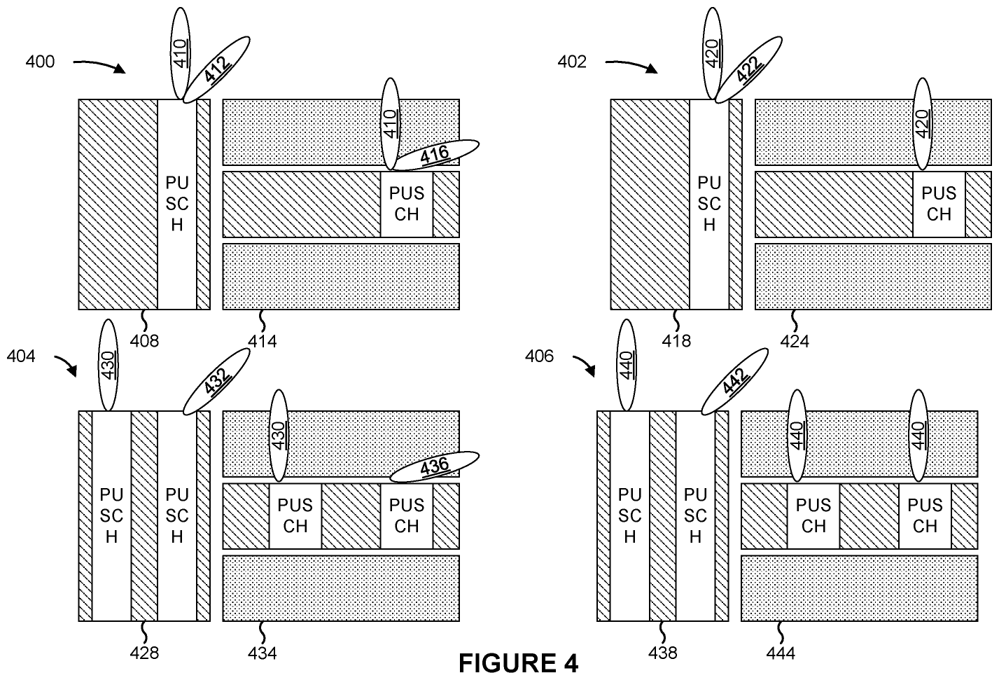

In example 300, mTRP communication in SBFD resources 315 is permitted. Examples 400, 402, 404, and 406 of FIG. 4 show further examples of SBFD and non-SBFD communication in conjunction with mTRP communication.

FIG. 4 is a diagram illustrating examples 400, 402, 404, and 406 of mTRP and single TRP (sTRP) communication in SBFD resources and non-SBFD resources. Uplink resources (such as uplink TDD symbols or slots of a non-SBFD resource, or an uplink subband of an SBFD resource) are illustrated by a hatched fill. Downlink resources (such as downlink TDD symbols or slots of a non-SBFD resource, or a downlink subband of an SBFD resource) are illustrated by a dotted fill. Uplink transmissions are illustrated with a particular beam direction. Each beam direction may correspond to a different TRP.

Examples 400 and 402 are examples where mTRP transmission in an SBFD resource is permitted. As shown in example 400, in a non-SBFD slot 408, the UE is permitted to perform mTRP communication, and thus transmits using a first beam 410 and a second beam 412. As shown, in an SBFD slot 414, the UE is permitted to perform mTRP communication, and thus transmits using the first beam 410 and a third beam 416. In some aspects, the UE may use the first beam 410 and the third beam 416.

In example 402, in a non-SBFD slot 418, the UE is permitted to perform mTRP communication, and thus transmits using a first beam 420 and a second beam 422. As shown, in an SBFD slot 424, the UE is not permitted to perform mTRP communication, and thus transmits using the only first beam 420. Example 400 is an example of SDM or single-frequency network (SFN) PUSCH transmission in TDD, and example 402 is an example of TDM PUSCH transmission in TDD.

Examples 404 and 406 are examples where mTRP transmission in an SBFD resource is not permitted. As shown in example 404, in a non-SBFD slot 428, the UE is permitted to perform mTRP communication, and thus transmits using a first beam 430 and a second beam 432. As shown, in an SBFD slot 434, the UE is permitted to perform mTRP communication, and thus transmits using the first beam 430 and a third beam 436.

In example 406, in a non-SBFD slot 438, the UE is permitted to perform mTRP communication, and thus transmits using a first beam 440 and a second beam 442. As shown, in an SBFD slot 444, the UE is not permitted to perform mTRP communication, and thus transmits using only a single beam (for example, the first beam 440). Example 404 is an example of SDM or SFN PUSCH transmission in TDD, and example 406 is an example of TDM PUSCH transmission in TDD.

mTRP uplink transmission may be enabled for a PUSCH or for a PUCCH. A PUSCH can be transmitted using TDM (examples 402 and 406), SFN (examples 400 and 404), or SDM (examples 400 and 404). A PUCCH can be transmitted using TDM or SFN, as some examples.

As indicated above, FIGS. 3 and 4 are provided as examples. Other examples may differ from what is described with regard to FIGS. 3 and 4.

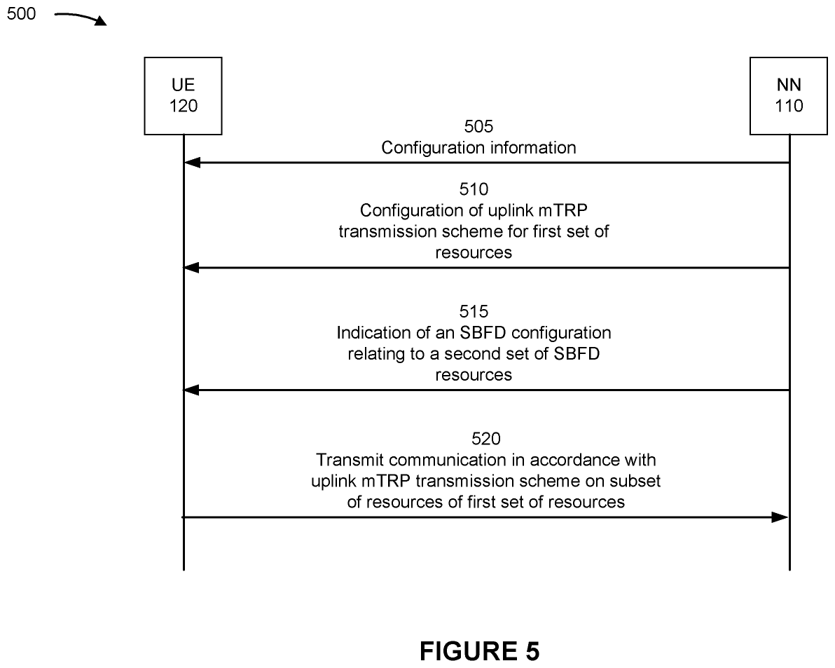

FIG. 5 is a diagram illustrating an example 500 of signaling relating to mTRP configuration in conjunction with SBFD resources. Example 500 includes a UE 120 and a network node 110. In some aspects, the network node 110 may include a gNB that is associated with multiple TRPs (not illustrated).

As shown by reference number 505, in some aspects, the network node 110 may transmit, and the UE 120 may receive, configuration information. For example, the network node 110 may receive the configuration information via RRC signaling, system information, or the like.

In some aspects, the configuration information may include one or more SRS resource set configurations. For example, an SRS resource set may be used to provide spatial parameters for transmission to an mTRP, since an SRS resource set is configured with these spatial parameters. In this example, the UE 120 can be indicated with two configured SRS resource sets (having different spatial parameters) where each of the two configured SRS resource sets corresponds to a different TRP. In some aspects, the UE 120 may be configured with more than two SRS resource sets. For example, the UE 120 may be configured with additional SRS resource sets, which may facilitate mTRP

PUSCH transmission in SBFD resources and non-SBFD resources. The SRS resource sets for SBFD and non-SBFD resources can be applicable for codebook-based transmission and for non-codebook-based transmission. In some aspects, the configuration of SRS resource sets, or the number or identities of configured SRS resource sets, can be used to implicitly indicate whether to perform uplink mTRP transmission or sTRP transmission in SBFD resources, as described with regard to reference number 520.

In some aspects, the UE 120 may be configured with two additional SRS resource sets, such as a total of four SRS resource sets. A first pair of SRS resource sets may be used for PUSCH transmission in a non-SBFD resource (such as non-SBFD resource 320), and a second pair of SRS resource sets, different from the first pair of SRS resource sets, may be used for PUSCH transmission in an SBFD resource (such as SBFD resource 315). This may facilitate switching between a first pair of TRPs and a second pair of TRPs in SBFD and non-SBFD resources.

In some aspects, the UE 120 may be configured with one additional SRS resource set, such as a total of three SRS resource sets. For example, a first SRS resource set of the three SRS resource sets may be used for PUSCH transmission on both SBFD resources and non-SBFD resources. SBFD resources may use the first SRS resource set and a second SRS resource set for PUSCH transmission, and non-SBFD resources may use the first SRS resource set and a third SRS resource set for PUSCH transmission.

In some aspects, the UE 120 may be configured with SRS resource sets that are applicable in both SBFD resources and non-SBFD resources. For example, a same two or more SRS resource sets may be applicable in both SBFD resources and non-SBFD resources.

In some aspects, each SRS resource set configured by the configuration information may include or be associated with information indicating whether the SRS resource set is applicable for SBFD resources or non-SBFD resources. If this information is not configured for an SRS resource set, the SRS resource set may be appliable for SBFD resources and non-SBFD resources (such as the first SRS resource set described above). In some aspects, a first SRS resource set in a set of SRS resource sets configured for SBFD resources (such as for the purposes of mapping SRS resource sets to TRPs) may be an SRS resource set with a lowest identifier. In some aspects, a first SRS resource set in a set of SRS resource sets configured for non-SBFD resources (such as for the purposes of mapping SRS resource sets to TRPs) may be an SRS resource set with a lowest identifier.

In some aspects, the configuration information may indicate a beam pattern for TDM repetition of a PUSCH or a PUCCH. A beam pattern may indicate a sequence of beams in time (which may or may not be cyclical). The UE 120 may switch beams in accordance with the beam pattern. For example, a first repetition may be transmitted using a first beam indicated by the beam pattern, a second repetition may be transmitted using a second beam indicated by the beam pattern, and so on. Examples of a beam pattern include a cyclic pattern [1212] (in which the UE 120 cycles between a first beam and a second beam for repetitions) and a sequential pattern [1122] (in which the UE 120 transmits a first two repetitions with a first beam and a second two repetitions with a second beam). In some aspects, different beam patterns may be configured for uplink transmission in SBFD resources, and for uplink transmission in non-SBFD resources. For example, beam patterns for SBFD resources may be sequential and beam patterns for non-SBFD resources may be cyclic. In this example, the UE 120 may switch from one beam pattern to the other beam pattern depending on whether the UE 120 is transmitting in an SBFD resource or a non-SBFD resource. For example, the UE 120 may use a beam pattern for SBFD resources while transmitting in an SBFD resource, and may use a beam pattern for non-SBFD resources while transmitting in a non-SBFD resource. Thus, the UE 120 may switch the beam pattern when transitioning between resource types. In some aspects, a configured beam pattern may be applicable for both SBFD and non-SBFD symbols. In this example, in some aspects, the UE 120 may reset the beam pattern after switching. For example, the UE 120 may transmit according to a beam pattern [121] in a non-SBFD resource, and then may reset the beam pattern to [121. . . ] (or [1′2′1′ . . . ] indicating different spatial parameters) upon switching to an SBFD resource. Alternatively, the UE 120 may continue the beam pattern after switching. For example, the UE 120 may transmit according to a cyclical beam pattern [121] in a non-SBFD resource, and then may reset the beam pattern to [212 . . . ] (or [2′1′2′ . . . ] indicating different spatial parameters) upon switching to an SBFD resource.

In some aspects, the configuration information may relate to channel state information (CSI) multiplexing. For example, the configuration information may configure the UE 120 to transmit CSI (such as aperiodic CSI (A-CSI) or semi-persistent CSI (SP-CSI)) on a number of PUSCH repetitions. For mTRP PUSCH transmission, the UE 120 may be configured to transmit (for example, piggyback, multiplex) an A-CSI or SP-CSI on two PUSCH repetitions if the two repetitions have the same length and if uplink control information other than the A-CSI/SP-CSI is not multiplexed on either of the two PUSCH repetitions. In some aspects, the CSI may be multiplexed on two repetitions of a PUSCH in a non-SBFD resource. In some aspects, the CSI may be multiplexed on two repetitions of a PUSCH in an SBFD resource. In some aspects, the CSI may be multiplexed on a repetition of a PUSCH in a non-SBFD resource and a repetition of the PUSCH in an SBFD resource. Thus, CSI multiplexing of PUSCH repetitions in mTRP may achieve spatial diversity, frequency diversity, and/or interference/channel diversity.

As shown by reference number 510, the network node 110 may transmit, and the UE 120 may receive, a configuration of an uplink mTRP transmission scheme for a first set of resources. For example, the configuration may schedule a PUSCH for transmission by the UE 120 on the first set of resources. In this example, the configuration may include dynamic signaling such as downlink control information (DCI) that indicates resources and parameters for transmission of the PUSCH. As another example, the configuration may configure a PUCCH for transmission by the UE 120 on the first set of resources. In this example, the configuration may include a MAC control element (MAC-CE) that indicates parameters for transmission of the PUCCH. In some aspects, the configuration may indicate spatial parameters (such as TCI states, SRS resource indicators, or the like), power control parameters (such as transmit power control (TPC) parameters), or other parameters for transmission to each TRP of multiple TRPs. The uplink mTRP transmission scheme may include a TDM transmission scheme, an SFN transmission scheme, or an SDM transmission scheme, which are described in more detail in connection with FIG. 4. In some aspects, the first set of resources may include one or more non-SBFD resources, such as one or more resources having an uplink resource type or a flexible resource type without the one or more resources having both uplink sub-bands and downlink sub-bands. In some aspects, the first set of resources may be configured with a TDD configuration.

As mentioned, in some aspects, the configuration of the uplink mTRP transmission scheme may include a MAC-CE. For example, the MAC-CE may activate up to 4 beams (for example, TCI states) or up to 4 sets of power control parameters for a given PUCCH resource. Thus, uplink mTRP transmission can be indicated across SBFD resources and non-SBFD resources on which a PUCCH is to be transmitted. Additionally, or alternatively, the configuration may include DCI (such as DCI format 1_1 or 1_2), which may include up to 4 transmit power control fields, enabling transmit power control for up to 4 TRPs across SBFD and non-SBFD resources.

In some aspects, the DCI may indicate transmission parameters for transmission using a same two TRPs across SBFD resources and non-SBFD resources, such as for repetition across SBFD symbols and non-SBFD symbols. The DCI may include one or more fields that indicate SRS resource set indicators, SRS resource indicators (SRIs), and transmit precoding matrix indicators (TPMIs) for the two TRPs. In this example, a size of the one or more fields may accommodate different numbers of SRS resources configured per TRP, such as a first number of SRS resources for an SBFD resource and a second number of SRS resources for a non-SBFD resource. For example, if a TRP0 is associated with an SRS resource set 0,2 in SBFD resources and non-SBFD symbols, with 4 SRS resources of this SRS resource set in SBFD resources and 2 SRS resources of this SRS resource set in non-SBFD resources, then a size of the one or more fields may be computed according to a maximum of 4 and 2.

In some aspects, the DCI may indicate transmission parameters for transmission using more than 2 TRPs across SBFD resources and non-SBFD resources. In this case, the DCI may include a field (such as an SRS resource set indicator field) that indicates whether to transmit a PUSCH using an sTRP transmission scheme or an uplink mTRP transmission scheme in SBFD resources. Additionally, or alternatively, the DCI may include one or more SRI fields to indicate SRS resources for a third SRS resource set and/or a fourth SRS resource set (corresponding to a third TRP and/or a fourth TRP) in SBFD resources (where the UE 120 may transmit to a first TRP and a second TRP in non-SBFD resources). Additionally, or alternatively, the DCI may include one or more TPMI fields to indicate a TPMI for SBFD resources. In some aspects, the one or more TPMI fields may be smaller than a baseline TPMI field, since a rank for the communication may be indicated by the baseline TPMI field (such as a TPMI field for a non-SBFD resource). Additionally, or alternatively, the DCI (such as DCI format 0_1 or 0_2) may be configured with and/or include one or more TPC fields indicating a closed-loop (CL) power control parameter for SBFD resources. If the one or more TPC fields are omitted, then a same set of power control parameters may apply for SBFD resources and non-SBFD resources. In some aspects, the DCI may include a bit that explicitly indicates whether the uplink mTRP transmission scheme is applicable to only non-SBFD resources, or to both SBFD resources and non-SBFD resources.

In some aspects, the network node 110 may configure PUSCH transmission, such as via a configured grant (CG) PUSCH configuration. For example, the network node 110 may configure a first CG-PUSCH for SBFD resources and may configure a second CG-PUSCH for non-SBFD resources.

As shown by reference number 515, the network node 110 may transmit, and the UE 120 may receive, an indication of an SBFD configuration relating to a second set of SBFD resources. For example, the indication of the SBFD configuration may include an SBFD time and frequency location. An SBFD time and frequency location may include information indicating a set of resources for SBFD communication, such as a start of a downlink sub-band, an end of a downlink sub-band, a start of an uplink sub-band, an end of an uplink sub-band, one or more guard bands between a downlink sub-band and an uplink sub-band, one or more time resources in which the SBFD communication is configured according to these sub-bands, or a combination thereof.

The second set of SBFD resources may at least partially overlap the first set of resources. For example, the SBFD configuration may configure at least one resource (for example, slot, symbol) of the first set of resources to be an SBFD resource. As mentioned above, the first set of resources (configured for the uplink mTRP transmission scheme) may also include one or more non-SBFD resources.

As shown by reference number 520, the UE 120 may transmit a communication in accordance with the uplink mTRP transmission scheme on a subset of resources of the first set of resources. The subset of resources can include fewer than all resources of the first set of resources, or can include all resources of the first set of resources.

The subset of resources may be derived from the SBFD configuration. For example, in some aspects, the uplink mTRP transmission scheme may be applicable only to non-SBFD resources (for example, slots, symbols), and may exclude the SBFD resources indicated by the SBFD configuration. In such examples, the subset of resources may include only non-SBFD resources, and the UE 120 may transmit on at least one SBFD resource of the first set of resources using an sTRP transmission scheme. Thus, the UE 120 may semi-statically switch from mTRP transmission schemes to sTRP transmission schemes (and vice versa) at the transition between non-SBFD resources and SBFD resources. The switching may be based on the semi-static SBFD/TDD pattern (that is, the SBFD configuration and the configuration of the first set of resources). As another example of deriving the subset of resources from the SBFD configuration, in some aspects, the uplink mTRP transmission scheme may be applicable to both non-SBFD resources (for example, slots, symbols) and SBFD resources. In such examples, the subset of resources may include non-SBFD resources and SBFD resources, and the UE 120 may transmit on all resources of the first set of resources using the uplink mTRP transmission scheme.

In some aspects, the UE 120 may use the same transmission parameters, such as the same spatial parameters (for example, TCI states) and/or power control parameters, for the communication in both SBFD resources and non-SBFD resources (for example, the UE 120 may communicate with the same TRPs across SBFD resources and non-SBFD resources). In some aspects, the UE 120 may use different transmission parameters, such as different spatial parameters (for example, TCI states) and/or power control parameters, for the communication in SBFD resources versus non-SBFD resources (for example, the UE 120 may communicate with different TRPs across SBFD resources and non-SBFD resources). Additional description of determination of spatial parameters and power control parameters is provided below.

In some aspects, the UE 120 may receive information indicating whether transmission using the uplink mTRP transmission scheme on SBFD resources is enabled. This information may be included in the configuration information shown by reference number 505, the configuration shown by reference number 510, or the indication shown by reference number 515. In some aspects, the information indicating whether transmission using the uplink mTRP transmission scheme on SBFD resources is enabled may be explicit, such as a flag in an RRC configuration (such as the configuration information shown by reference number 505 or the configuration shown by reference number 510). If the flag disables transmission using the uplink mTRP transmission scheme on SBFD resources, the UE 120 may fall back to sTRP transmission in the SBFD resources, and if the flag enables the transmission, the UE 120 may transmit using the uplink mTRP transmission scheme in the SBFD resources. If the flag is not configured, the UE 120 may proceed according to a default behavior. For example, the default behavior may include falling back to sTRP transmission in an SBFD resource (and using a single TCI state and a single set of power control parameters corresponding to a single TRP of the multiple TRPs of the uplink mTRP transmission scheme), or continuing to transmit using the uplink mTRP transmission scheme in the SBFD resource (such as using a same set of TCI states and/or power control parameters of the multiple TRPs).

In some aspects, the information indicating whether transmission using the uplink mTRP transmission scheme on SBFD resources is enabled may be implicit. For example, the information may be based on a configuration or indication of a number of TCI states (which may include unified TCI states as described elsewhere herein) in SBFD resources and in non-SBFD resources. For example, if the UE 120 is indicated with pair of unified TCI states for uplink transmission in non-SBFD resources and a different pair of unified TCI states for uplink transmission in SBFD resources, then the uplink mTRP transmission scheme may be enabled in SBFD resources. As another example, the information may be based on a number of SRS resource sets configured for SBFD resources and for non-SBFD resources. For example, if the network node 110 configures two SRS resource sets for non-SBFD resources and a single SRS resource set for SBFD resources, then the UE 120 may fall back to sTRP PUSCH transmission in the SBFD resources. If the network node 110 configures two SRS resource sets for non-SBFD resources and two SRS resource sets for SBFD resources, then the UE 120 may perform the uplink mTRP transmission scheme in the SBFD resources. Additional description of SRS resource set configuration is provided in connection with reference number 505, above.

In some aspects, when transmitting using the sTRP transmission scheme in an SBFD resource, the UE 120 may be configured with an SRS resource set specific to sTRP transmission schemes in SBFD resources. For example, the UE 120 may fallback to sTRP transmission on a subset of frequency resources (for example, an uplink sub-band) of a non-SBFD resource. As another example, the UE 120 may fallback to sTRP transmission to a different TRP (such as with different spatial parameters and/or power control parameters) than a TRP to which the UE 120 transmitted on the non-SBFD resource. In some aspects, when transmitting using the sTRP transmission scheme in an SBFD resource, the UE 120 may use an SRS resource set of multiple SRS resource sets configured for the uplink mTRP transmission scheme. For example, the UE 120 may use a proper subset of SRS resources of the SRS resource set. In some aspects, the UE 120 may use the SRS resource set of the multiple SRS resource sets according to a rule. For example, the UE 120 may use an SRS resource set indicated by a configuration, or may use a first SRS resource set (for example, with a lowest index).

In some aspects, when transmitting using the sTRP transmission scheme in an SBFD resource, the UE 120 may transmit using an explicitly indicated TCI state (such as a unified TCI state) or SRS resource set (such as via an SRS resource set indicator). Additionally, or alternatively, the UE 120 may transmit in accordance with a beam pattern. At a transition from mTRP transmission (on a non-SBFD resource) to sTRP transmission (on an SBFD resource), the UE 120 may modify the beam pattern to be suitable for sTRP transmission to a single TRP. For example, the UE 120 may modify an mTRP beam pattern [12121] by dropping occasions corresponding to a second TRP: [111]. As another example, the UE 120 may modify the mTRP beam pattern [12121] by switching occasions corresponding to the second TRP to correspond to the first TRP: [11111].

In some aspects, the UE 120 may transmit repetitions of the communication. For example, the UE 120 may transmit repetitions of a PUSCH. The UE 120 may transmit the repetitions in accordance with a redundancy version sequence. A redundancy version sequence may be configured or indicated to the UE 120. A redundancy version sequence may indicate a sequence of redundancy versions (for example, a redundancy version sequence [0231] includes four redundancy versions: 0, 2, 3, and 1). Each redundancy version may indicate a set of bits to be selected from a buffer (such as a circular buffer) for transmission of a corresponding repetition. The redundancy version sequence may be applied separately for PUSCH repetitions corresponding to a first TRP and a second TRP. Furthermore, a configured redundancy version offset may be applied for a starting redundancy version of the second TRP. For example, with two TRPs and eight repetitions, a first TRP may use a redundancy version sequence of [0231] and a second TRP may use a redundancy version sequence defined by modulo (offset+[0231]). In some aspects, the UE 120 may reset (for example, start over at a first value of) the redundancy version sequence at a boundary or transition from an SBFD resource to a non-SBFD resource, or at a boundary or transition from a non-SBFD resource to an SBFD resource.

As indicated above, FIG. 5 is provided as an example. Other examples may differ from what is described with regard to FIG. 5.

FIG. 6 is a flowchart illustrating an example process 600 performed, for example, at a UE or an apparatus of a UE that supports mTRP transmission for SBFD in accordance with the present disclosure. Example process 600 is an example where the apparatus or the UE (for example, UE 120) performs operations associated with mTRP transmission for SBFD.

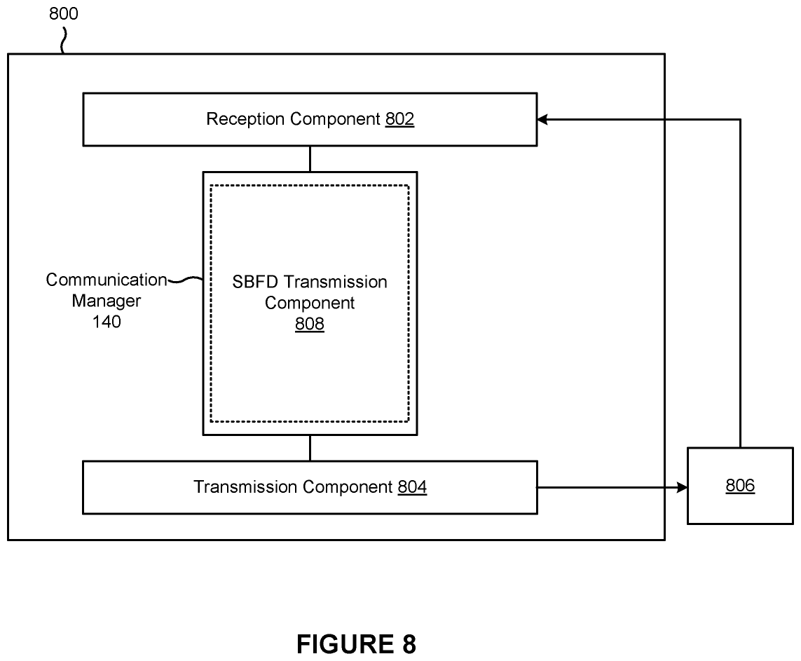

As shown in FIG. 6, in some aspects, process 600 may include receiving a configuration of an uplink mTRP transmission scheme for a first set of resources (block 610). For example, the apparatus or the UE (such as by using communication manager 140 or reception component 802, depicted in FIG. 8) may receive a configuration of an uplink mTRP transmission scheme for a first set of resources, as described above.

As further shown in FIG. 6, in some aspects, process 600 may include receiving an indication of an SBFD configuration relating to a second set of resources, the first set of resources including at least one resource of the second set of resources, wherein the at least one resource is at least one SBFD resource (block 620). For example, the apparatus or the UE (such as by using communication manager 140 or reception component 802, depicted in FIG. 8) may receive an indication of an SBFD configuration relating to a second set of resources, the first set of resources including at least one resource of the second set of resources, wherein the at least one resource is at least one SBFD resource, as described above.

As further shown in FIG. 6, in some aspects, process 600 may include transmitting a communication in accordance with the uplink mTRP transmission scheme on a subset of resources of the first set of resources, the subset of resources being derived from the SBFD configuration (block 630). For example, the apparatus or the UE (such as by using communication manager 140 or transmission component 804, depicted in FIG. 8) may transmit a communication in accordance with the uplink mTRP transmission scheme on a subset of resources of the first set of resources, the subset of resources being derived from the SBFD configuration, as described above.

Process 600 may include additional aspects, such as any single aspect or any combination of aspects described below or in connection with one or more other processes described elsewhere herein.

In a first additional aspect, the subset of resources includes only non-SBFD resources of the first set of resources.

In a second additional aspect, alone or in combination with the first aspect, process 600 includes transmitting on the at least one SBFD resource that is included in the first set of resources using a single transmission reception point transmission scheme.

In a third additional aspect, alone or in combination with one or more of the first and second aspects, the non-SBFD resources are indicated, by a time division duplexing pattern, as uplink or flexible symbols with configured uplink or downlink sub-bands.

In a fourth additional aspect, alone or in combination with one or more of the first through third aspects, the subset of resources includes the at least one SBFD resource.

In a fifth additional aspect, alone or in combination with one or more of the first through fourth aspects, transmitting the communication in accordance with the mTRP transmission scheme on the subset of resources further comprises transmitting the communication using a first transmission parameter on a non-SBFD resource of the subset of resources and transmitting the communication using a second transmission parameter on the at least one SBFD resource.

In a sixth additional aspect, alone or in combination with one or more of the first through fifth aspects, the first transmission parameter is associated with a first set of TRPs and the second transmission parameter is associated with a second set of TRPs.

In a seventh additional aspect, alone or in combination with one or more of the first through sixth aspects, process 600 includes transmitting the communication in accordance with the information.

In an eighth additional aspect, alone or in combination with one or more of the first through seventh aspects, the information indicating whether transmission using the mTRP transmission scheme on SBFD resources is enabled comprises a radio resource control (RRC) configuration.

In a ninth additional aspect, alone or in combination with one or more of the first through eighth aspects, the information indicating whether transmission using the mTRP transmission scheme on SBFD resources is enabled comprises at least one of a configuration of a number of transmission configuration indicator (TCI) states, or a configuration of a number of sounding reference signal resource sets.

In a tenth additional aspect, alone or in combination with one or more of the first through ninth aspects, the communication is a physical uplink control channel (PUCCH) communication, and process 600 includes receiving dynamic signaling indicating a plurality of transmission parameters for the PUCCH communication, wherein the plurality of transmission parameters include more than two transmission parameters.

In an eleventh additional aspect, alone or in combination with one or more of the first through tenth aspects, a first set of transmission parameters, of the more than two transmission parameters, are for a non-SBFD resource, and a second set of transmission parameters, of the more than two transmission parameters, are for an SBFD resource.

In a twelfth additional aspect, alone or in combination with one or more of the first through eleventh aspects, process 600 includes transmitting the communication in an SBFD resource using a first subset of the plurality of SRS resource sets, and transmitting another communication in a non-SBFD resource, in accordance with the mTRP transmission scheme, using a second subset of the plurality of SRS resource sets.

In a thirteenth additional aspect, alone or in combination with one or more of the first through twelfth aspects, the first subset and the second subset are a same subset.

In a fourteenth additional aspect, alone or in combination with one or more of the first through thirteenth aspects, the first subset is different from the second subset with regard to at least one SRS resource set of the plurality of SRS resource sets.

In a fifteenth additional aspect, alone or in combination with one or more of the first through fourteenth aspects, transmitting the communication in accordance with the mTRP transmission scheme further comprises transmitting the communication on an SBFD resource using a first beam pattern configuration and a non-SBFD resource using a second beam pattern configuration different than the first beam pattern configuration.

In a sixteenth additional aspect, alone or in combination with one or more of the first through fifteenth aspects, transmitting the communication in accordance with the mTRP transmission scheme further comprises transmitting the communication on an SBFD resource and a non-SBFD resource using a same beam pattern configuration.

In a seventeenth additional aspect, alone or in combination with one or more of the first through sixteenth aspects, process 600 includes transmitting another communication on the at least one SBFD resource that is included in the first set of resources using a single TRP transmission scheme, wherein the other communication is associated with an SRS resource set configured for transmission using the single TRP transmission scheme on the at least one SBFD resource.

In an eighteenth additional aspect, alone or in combination with one or more of the first through seventeenth aspects, process 600 includes transmitting another communication on the at least one SBFD resource that is included in the first set of resources using a single TRP transmission scheme, wherein the other communication is associated with an SRS resource set configured for transmission using the mTRP transmission scheme on the at least one SBFD resource, and wherein the other communication uses a proper subset of SRS resources of the SRS resource set.

In a nineteenth additional aspect, alone or in combination with one or more of the first through eighteenth aspects, process 600 includes receiving a configuration of a beam pattern for transmission on the at least one SBFD resource using a single TRP transmission scheme, wherein the configuration is via at least one of a transmission configuration indicator, or a sounding reference signal resource set indicator, and transmitting another communication on the at least one SBFD resource using the single TRP transmission scheme in accordance with the configuration.

In a twentieth additional aspect, alone or in combination with one or more of the first through nineteenth aspects, process 600 includes transmitting another communication on the at least one SBFD resource using a single TRP transmission scheme in accordance with a beam pattern for the mTRP transmission scheme, wherein the beam pattern is modified for the single TRP transmission scheme.

In a twenty-first additional aspect, alone or in combination with one or more of the first through twentieth aspects, transmitting the communication in accordance with the mTRP transmission scheme further comprises transmitting the communication on an SBFD resource and a non-SBFD resource, wherein the communication includes channel state information multiplexed on a physical uplink shared channel.

In a twenty-second additional aspect, alone or in combination with one or more of the first through twenty-first aspects, transmitting the communication in accordance with the mTRP transmission scheme further comprises transmitting the communication on an SBFD resource and a non-SBFD resource, wherein a redundancy version pattern is reset at a boundary between the SBFD resource and the non-SBFD resource.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network node or an apparatus of a network node that supports mTRP transmission for SBFD in accordance with the present disclosure. Example process 700 is an example where the apparatus or the network node (for example, network node 110) performs operations associated with mTRP transmission for SBFD.

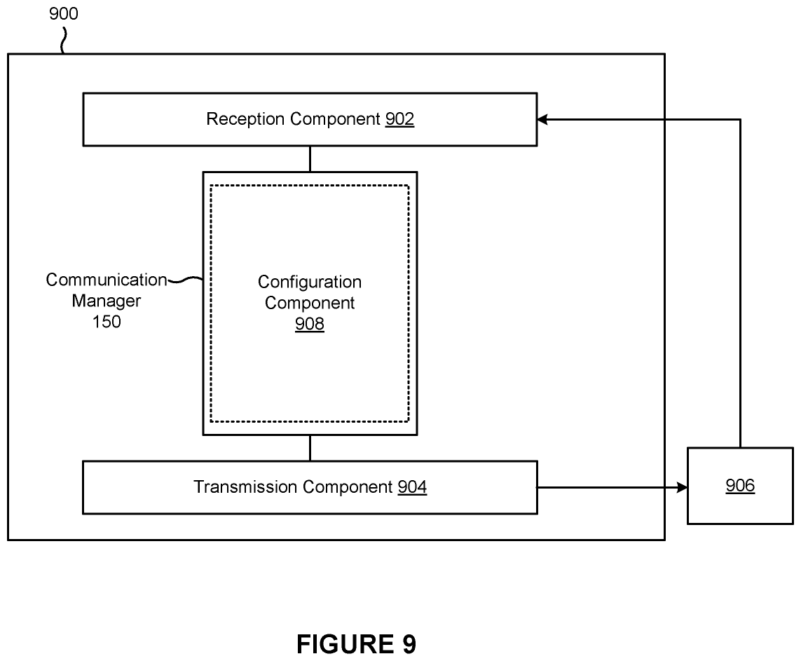

As shown in FIG. 7, in some aspects, process 700 may include transmitting a configuration of an uplink mTRP transmission scheme for a first set of resources (block 710). For example, the network node (such as by using communication manager 150 or transmission component 904, depicted in FIG. 9) may transmit a configuration of an uplink mTRP transmission scheme for a first set of resources, as described above.

As further shown in FIG. 7, in some aspects, process 700 may include transmitting an indication of an SBFD configuration relating to a second set of resources, the first set of resources including at least one resource of the second set of resources, wherein the at least one resource is at least one SBFD resource (block 720). For example, the network node (such as by using communication manager 150 or transmission component 904, depicted in FIG. 9) may transmit an indication of an SBFD configuration relating to a second set of resources, the first set of resources including at least one resource of the second set of resources, wherein the at least one resource is at least one SBFD resource, as described above.

As further shown in FIG. 7, in some aspects, process 700 may include receiving a communication in accordance with the uplink mTRP transmission scheme on a subset of resources of the first set of resources, the subset of resources being derived from the SBFD configuration (block 730). For example, the network node (such as by using communication manager 150 or reception component 902, depicted in FIG. 9) may receive a communication in accordance with the uplink mTRP transmission scheme on a subset of resources of the first set of resources, the subset of resources being derived from the SBFD configuration, as described above.

Process 700 may include additional aspects, such as any single aspect or any combination of aspects described below or in connection with one or more other processes described elsewhere herein.

In a first additional aspect, the subset of resources includes only non-SBFD resources of the first set of resources.

In a second additional aspect, alone or in combination with the first aspect, process 700 includes receiving on the at least one SBFD resource that is included in the first set of resources using a single transmission reception point transmission scheme.

In a third additional aspect, alone or in combination with one or more of the first and second aspects, the non-SBFD resources are indicated, by a time division duplexing pattern, as uplink or flexible symbols with configured uplink or downlink sub-bands.

In a fourth additional aspect, alone or in combination with one or more of the first through third aspects, the subset of resources includes the at least one SBFD resource.

In a fifth additional aspect, alone or in combination with one or more of the first through fourth aspects, receiving the communication in accordance with the mTRP transmission scheme on the subset of resources further comprises receiving the communication using a first transmission parameter on a non-SBFD resource of the subset of resources and receiving the communication using a second transmission parameter on the at least one SBFD resource.

In a sixth additional aspect, alone or in combination with one or more of the first through fifth aspects, the first transmission parameter is associated with a first set of TRPs and the second transmission parameter is associated with a second set of TRPs.

In a seventh additional aspect, alone or in combination with one or more of the first through sixth aspects, process 700 includes receiving the communication in accordance with the information.

In an eighth additional aspect, alone or in combination with one or more of the first through seventh aspects, the information indicating whether transmission using the mTRP transmission scheme on SBFD resources is enabled comprises a radio resource control (RRC) configuration.

In a ninth additional aspect, alone or in combination with one or more of the first through eighth aspects, the information indicating whether transmission using the mTRP transmission scheme on SBFD resources is enabled comprises at least one of a configuration of a number of TCI states, or a configuration of a number of sounding reference signal resource sets.

In a tenth additional aspect, alone or in combination with one or more of the first through ninth aspects, the communication is a PUCCH communication, and process 700 includes transmitting dynamic signaling indicating a plurality of transmission parameters for the PUCCH communication, wherein the plurality of transmission parameters include more than two transmission parameters.

In an eleventh additional aspect, alone or in combination with one or more of the first through tenth aspects, a first set of transmission parameters, of the more than two transmission parameters, are for a non-SBFD resource, and wherein a second set of transmission parameters, of the more than two transmission parameters, are for an SBFD resource.

In a twelfth additional aspect, alone or in combination with one or more of the first through eleventh aspects, process 700 includes receiving the communication in an SBFD resource using a first subset of the plurality of SRS resource sets, and receiving another communication in a non-SBFD resource, in accordance with the mTRP transmission scheme, using a second subset of the plurality of SRS resource sets.

In a thirteenth additional aspect, alone or in combination with one or more of the first through twelfth aspects, the first subset and the second subset are a same subset.

In a fourteenth additional aspect, alone or in combination with one or more of the first through thirteenth aspects, the first subset is different from the second subset with regard to at least one SRS resource set of the plurality of SRS resource sets.

In a fifteenth additional aspect, alone or in combination with one or more of the first through fourteenth aspects, receiving the communication in accordance with the mTRP transmission scheme further comprises receiving the communication on an SBFD resource using a first beam pattern configuration and a non-SBFD resource using a second beam pattern configuration different than the first beam pattern configuration.

In a sixteenth additional aspect, alone or in combination with one or more of the first through fifteenth aspects, receiving the communication in accordance with the mTRP transmission scheme further comprises receiving the communication on an SBFD resource and a non-SBFD resource using a same beam pattern configuration.

In a seventeenth additional aspect, alone or in combination with one or more of the first through sixteenth aspects, process 700 includes receiving another communication on the at least one SBFD resource that is included in the first set of resources using a single TRP transmission scheme, wherein the other communication is associated with an SRS resource set configured for transmission using the single TRP transmission scheme on the at least one SBFD resource.

In an eighteenth additional aspect, alone or in combination with one or more of the first through seventeenth aspects, process 700 includes receiving another communication on the at least one SBFD resource that is included in the first set of resources using a single TRP transmission scheme, wherein the other communication is associated with an SRS resource set configured for transmission using the mTRP transmission scheme on the at least one SBFD resource, and wherein the other communication uses a proper subset of SRS resources of the SRS resource set.

In a nineteenth additional aspect, alone or in combination with one or more of the first through eighteenth aspects, process 700 includes transmitting a configuration of a beam pattern for transmission on the at least one SBFD resource using a single TRP transmission scheme, wherein the configuration is via at least one of a transmission configuration indicator, or a sounding reference signal resource set indicator, and receiving another communication on the at least one SBFD resource using the single TRP transmission scheme in accordance with the configuration.

In a twentieth additional aspect, alone or in combination with one or more of the first through nineteenth aspects, process 700 includes receiving another communication on the at least one SBFD resource using a single TRP transmission scheme in accordance with a beam pattern for the mTRP transmission scheme, wherein the beam pattern is modified for the single TRP transmission scheme.

In a twenty-first additional aspect, alone or in combination with one or more of the first through twentieth aspects, receiving the communication in accordance with the mTRP transmission scheme further comprises receiving the communication on an SBFD resource and a non-SBFD resource, wherein the communication includes channel state information multiplexed on a physical uplink shared channel.

In a twenty-second additional aspect, alone or in combination with one or more of the first through twenty-first aspects, receiving the communication in accordance with the mTRP transmission scheme further comprises receiving the communication on an SBFD resource and a non-SBFD resource, wherein a redundancy version pattern is reset at a boundary between the SBFD resource and the non-SBFD resource.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports mTRP transmission for SBFD in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIGS. 3-5. Additionally or alternatively, the apparatus 800 may be configured to and/or operable to perform one or more processes described herein, such as process 600 of FIG. 6. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the UE described above in connection with FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 804 may be co-located with the reception component 802 in one or more transceivers.

The communication manager 140 may receive or may cause the reception component 802 to receive a configuration of an uplink multiple transmission reception point (TRP) (mTRP) transmission scheme for a first set of resources. The communication manager 140 may receive or may cause the reception component 802 to receive an indication of a sub-band full duplex (SBFD) configuration relating to a second set of SBFD resources, the first set of resources including at least one SBFD resource of the second set of SBFD resources. The communication manager 140 may transmit or may cause the transmission component 804 to transmit a communication in accordance with the uplink mTRP transmission scheme on a subset of resources of the first set of resources, the subset of resources being derived from the SBFD configuration. In some aspects, the communication manager 140 may perform one or more operations described elsewhere herein as being performed by one or more components of the communication manager 140.

The communication manager 140 may include one or more controllers/processors, and/or one or more memories of the UE described above in connection with FIG. 2. In some aspects, the communication manager 140 includes a set of components, such as an SBFD transmission component 808. Alternatively, the set of components may be separate and distinct from the communication manager 140. In some aspects, one or more components of the set of components may include or may be implemented within one or more controllers/processors, one or more memories, of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive a configuration of an uplink mTRP transmission scheme for a first set of resources. The reception component 802 may receive an indication of an SBFD configuration relating to a second set of SBFD resources, the first set of resources including at least one SBFD resource of the second set of SBFD resources. The transmission component 804 or the SBFD transmission component 808 may transmit a communication in accordance with the uplink mTRP transmission scheme on a subset of resources of the first set of resources, the subset of resources being derived from the SBFD configuration.

The transmission component 804 or the SBFD transmission component 808 may transmit on the at least one SBFD resource that is included in the first set of resources using a single transmission reception point transmission scheme.

The transmission component 804 may transmit the communication in accordance with the information.

The transmission component 804 or the SBFD transmission component 808 may transmit the communication in an SBFD resource using a first subset of the plurality of SRS resource sets and another communication in a non-SBFD resource, in accordance with the mTRP transmission scheme, using a second subset of the plurality of SRS resource sets.

The transmission component 804 may transmit another communication on the at least one SBFD resource that is included in the first set of resources using a single TRP transmission scheme, wherein the other communication is associated with an SRS resource set configured for transmission using the single TRP transmission scheme on the at least one SBFD resource.

The transmission component 804 may transmit another communication on the at least one SBFD resource that is included in the first set of resources using a single TRP transmission scheme, wherein the other communication is associated with an SRS resource set configured for transmission using the mTRP transmission scheme on the at least one SBFD resource, and wherein the other communication uses a proper subset of SRS resources of the SRS resource set.

The reception component 802 may receive a configuration of a beam pattern for transmission on the at least one SBFD resource using a single TRP transmission scheme, wherein the configuration is via at least one of a transmission configuration indicator, or a sounding reference signal resource set indicator; and transmit another communication on the at least one SBFD resource using the single TRP transmission scheme in accordance with the configuration.

The transmission component 804 may transmit another communication on the at least one SBFD resource using a single TRP transmission scheme in accordance with a beam pattern for the mTRP transmission scheme, wherein the beam pattern is modified for the single TRP transmission scheme.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports mTRP transmission in SBFD in accordance with the present disclosure. The apparatus 900 may be a network node, or a network node may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 3-5. Additionally or alternatively, the apparatus 900 may be configured to and/or operable to perform one or more processes described herein, such as process 700 of FIG. 7. In some aspects, the apparatus 900 may include one or more components of the network node described above in connection with FIG. 2.

The reception component 902 may receive communications, such as reference signals, control information, and/or data communications, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the network node described above in connection with FIG. 2.

The transmission component 904 may transmit communications, such as reference signals, control information, and/or data communications, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 904 may be co-located with the reception component 902 in one or more transceivers.

The communication manager 150 may transmit or may cause the transmission component 904 to transmit a configuration of an uplink multiple transmission reception point (TRP) (mTRP) transmission scheme for a first set of resources. The communication manager 150 may transmit or may cause the transmission component 904 to transmit an indication of a sub-band full duplex (SBFD) configuration relating to a second set of SBFD resources, the first set of resources including at least one SBFD resource of the second set of SBFD resources. The communication manager 150 may receive or may cause the reception component 902 to receive a communication in accordance with the uplink mTRP transmission scheme on a subset of resources of the first set of resources, the subset of resources being derived from the SBFD configuration. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a configuration component 908. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 904 or the configuration component 908 may transmit a configuration of an uplink mTRP transmission scheme for a first set of resources. The transmission component 904 or the configuration component 908 may transmit an indication of an SBFD configuration relating to a second set of SBFD resources, the first set of resources including at least one SBFD resource of the second set of SBFD resources. The reception component 902 may receive a communication in accordance with the uplink mTRP transmission scheme on a subset of resources of the first set of resources, the subset of resources being derived from the SBFD configuration.

The reception component 902 may receive on the at least one SBFD resource that is included in the first set of resources using a single transmission reception point transmission scheme.

The reception component 902 may receive the communication in accordance with the information.

The reception component 902 may receive the communication in an SBFD resource using a first subset of the plurality of SRS resource sets wherein the method further comprises receiving another communication in a non-SBFD resource, in accordance with the mTRP transmission scheme, using a second subset of the plurality of SRS resource sets.

The reception component 902 may receive another communication on the at least one SBFD resource that is included in the first set of resources using a single TRP transmission scheme, wherein the other communication is associated with an SRS resource set configured for transmission using the single TRP transmission scheme on the at least one SBFD resource.

The reception component 902 may receive another communication on the at least one SBFD resource that is included in the first set of resources using a single TRP transmission scheme, wherein the other communication is associated with an SRS resource set configured for transmission using the mTRP transmission scheme on the at least one SBFD resource, and wherein the other communication uses a proper subset of SRS resources of the SRS resource set.

The transmission component 904 or the configuration component 908 may transmit a configuration of a beam pattern for transmission on the at least one SBFD resource using a single TRP transmission scheme, wherein the configuration is via at least one of a transmission configuration indicator, or a sounding reference signal resource set indicator; and receiving another communication on the at least one SBFD resource using the single TRP transmission scheme in accordance with the configuration.

The reception component 902 may receive another communication on the at least one SBFD resource using a single TRP transmission scheme in accordance with a beam pattern for the mTRP transmission scheme, wherein the beam pattern is modified for the single TRP transmission scheme.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed at a user equipment (UE), comprising: receiving a configuration of an uplink multiple transmission reception point (TRP) (mTRP) transmission scheme for a first set of resources; receiving an indication of a sub-band full duplex (SBFD) configuration relating to a second set of resources, the first set of resources including at least one resource of the second set of resources, wherein the at least one resource is at least one SBFD resource; and transmitting a communication in accordance with the uplink mTRP transmission scheme on a subset of resources of the first set of resources, the subset of resources being derived from the SBFD configuration.
Aspect 2: The method of Aspect 1, wherein the subset of resources includes only non-SBFD resources of the first set of resources.
Aspect 3: The method of Aspect 2, further comprising transmitting on the at least one SBFD resource that is included in the first set of resources using a single transmission reception point transmission scheme.
Aspect 4: The method of Aspect 2, wherein the non-SBFD resources are indicated, by a time division duplexing pattern, as uplink or flexible symbols with configured uplink or downlink sub-bands.
Aspect 5: The method of any of Aspects 1-4, wherein the subset of resources includes the at least one SBFD resource.
Aspect 6: The method of Aspect 5, wherein transmitting the communication in accordance with the mTRP transmission scheme on the subset of resources further comprises transmitting the communication using a first transmission parameter on a non-SBFD resource of the subset of resources and transmitting the communication using a second transmission parameter on the at least one SBFD resource.
Aspect 7: The method of Aspect 6, wherein the first transmission parameter is associated with a first set of TRPs and the second transmission parameter is associated with a second set of TRPs.
Aspect 8: The method of any of Aspects 1-7, further comprising receiving information indicating whether transmission using the mTRP transmission scheme on SBFD resources is enabled, wherein transmitting the communication in accordance with the mTRP transmission scheme further comprises transmitting the communication in accordance with the information.
Aspect 9: The method of Aspect 8, wherein the information indicating whether transmission using the mTRP transmission scheme on SBFD resources is enabled comprises a radio resource control (RRC) configuration.
Aspect 10: The method of Aspect 8, wherein the information indicating whether transmission using the mTRP transmission scheme on SBFD resources is enabled comprises at least one of: a configuration of a number of transmission configuration indicator (TCI) states, or a configuration of a number of sounding reference signal resource sets.
Aspect 11: The method of any of Aspects 1-10, wherein the communication is a physical uplink control channel (PUCCH) communication, and wherein the method further comprises receiving dynamic signaling indicating a plurality of transmission parameters for the PUCCH communication, wherein the plurality of transmission parameters include more than two transmission parameters.
Aspect 12: The method of Aspect 11, wherein a first set of transmission parameters, of the more than two transmission parameters, are for a non-SBFD resource, and wherein a second set of transmission parameters, of the more than two transmission parameters, are for the at least one SBFD resource.
Aspect 13: The method of any of Aspects 1-12, further comprising receiving a configuration of a plurality of sounding reference signal resource (SRS) resource sets, wherein transmitting the communication further comprises transmitting the communication in the at least one SBFD resource using a first subset of the plurality of SRS resource sets, and wherein the method further comprises transmitting another communication in a non-SBFD resource, in accordance with the mTRP transmission scheme, using a second subset of the plurality of SRS resource sets.
Aspect 14: The method of Aspect 13, where the first subset and the second subset are a same subset.
Aspect 15: The method of Aspect 13, wherein the first subset is different from the second subset with regard to at least one SRS resource set of the plurality of SRS resource sets.
Aspect 16: The method of any of Aspects 1-15, wherein transmitting the communication in accordance with the mTRP transmission scheme further comprises transmitting the communication on the at least one SBFD resource using a first beam pattern configuration and a non-SBFD resource using a second beam pattern configuration different than the first beam pattern configuration.
Aspect 17: The method of any of Aspects 1-16, wherein transmitting the communication in accordance with the mTRP transmission scheme further comprises transmitting the communication on the at least one SBFD resource and a non-SBFD resource using a same beam pattern configuration.
Aspect 18: The method of any of Aspects 1-17, further comprising transmitting another communication on the at least one SBFD resource that is included in the first set of resources using a single TRP transmission scheme, wherein the other communication is associated with a sounding reference signal (SRS) resource set configured for transmission using the single TRP transmission scheme on the at least one SBFD resource.
Aspect 19: The method of any of Aspects 1-18, further comprising transmitting another communication on the at least one SBFD resource that is included in the first set of resources using a single TRP transmission scheme, wherein the other communication is associated with a sounding reference signal (SRS) resource set configured for transmission using the mTRP transmission scheme on the at least one SBFD resource, and wherein the other communication uses a proper subset of SRS resources of the SRS resource set.
Aspect 20: The method of any of Aspects 1-19, further comprising receiving a configuration of a beam pattern for transmission on the at least one SBFD resource using a single TRP transmission scheme, wherein the configuration is via at least one of: a transmission configuration indicator, or a sounding reference signal resource set indicator; and transmitting another communication on the at least one SBFD resource using the single TRP transmission scheme in accordance with the configuration.
Aspect 21: The method of any of Aspects 1-20, further comprising transmitting another communication on the at least one SBFD resource using a single TRP transmission scheme in accordance with a beam pattern for the mTRP transmission scheme, wherein the beam pattern is modified for the single TRP transmission scheme.
Aspect 22: The method of any of Aspects 1-21, wherein transmitting the communication in accordance with the mTRP transmission scheme further comprises transmitting the communication on the at least one SBFD resource and a non-SBFD resource, wherein the communication includes channel state information multiplexed on a physical uplink shared channel.
Aspect 23: The method of any of Aspects 1-22, wherein transmitting the communication in accordance with the mTRP transmission scheme further comprises transmitting the communication on the at least one SBFD resource and a non-SBFD resource, wherein a redundancy version pattern is reset at a boundary between the at least one SBFD resource and the non-SBFD resource.
Aspect 24: A method of wireless communication performed at a network node, comprising: transmitting a configuration of an uplink multiple transmission reception point (TRP) (mTRP) transmission scheme for a first set of resources; transmitting an indication of a sub-band full duplex (SBFD) configuration relating to a second set of resources, the first set of resources including at least one resource of the second set of resources, wherein the at least one resource is at least one SBFD resource; and receiving a communication in accordance with the uplink mTRP transmission scheme on a subset of resources of the first set of resources, the subset of resources being derived from the SBFD configuration.
Aspect 25: The method of Aspect 24, wherein the subset of resources includes only non-SBFD resources of the first set of resources.
Aspect 26: The method of Aspect 25, further comprising receiving on the at least one SBFD resource that is included in the first set of resources using a single transmission reception point transmission scheme.
Aspect 27: The method of Aspect 25, wherein the non-SBFD resources are indicated, by a time division duplexing pattern, as uplink or flexible symbols with configured uplink or downlink sub-bands.
Aspect 28: The method of any of Aspects 24-27, wherein the subset of resources includes the at least one SBFD resource.
Aspect 29: The method of Aspect 28, wherein receiving the communication in accordance with the mTRP transmission scheme on the subset of resources further comprises receiving the communication using a first transmission parameter on a non-SBFD resource of the subset of resources and receiving the communication using a second transmission parameter on the at least one SBFD resource.
Aspect 30: The method of Aspect 29, wherein the first transmission parameter is associated with a first set of TRPs and the second transmission parameter is associated with a second set of TRPs.
Aspect 31: The method of any of Aspects 24-30, further comprising transmitting information indicating whether transmission using the mTRP transmission scheme on SBFD resources is enabled, wherein receiving the communication in accordance with the mTRP transmission scheme further comprises receiving the communication in accordance with the information.
Aspect 32: The method of Aspect 31, wherein the information indicating whether transmission using the mTRP transmission scheme on SBFD resources is enabled comprises a radio resource control (RRC) configuration.
Aspect 33: The method of Aspect 31, wherein the information indicating whether transmission using the mTRP transmission scheme on SBFD resources is enabled comprises at least one of: a configuration of a number of transmission configuration indicator (TCI) states, or a configuration of a number of sounding reference signal resource sets.
Aspect 34: The method of any of Aspects 24-33, wherein the communication is a physical uplink control channel (PUCCH) communication, and wherein the method further comprises transmitting dynamic signaling indicating a plurality of transmission parameters for the PUCCH communication, wherein the plurality of transmission parameters include more than two transmission parameters.
Aspect 35: The method of Aspect 34, wherein a first set of transmission parameters, of the more than two transmission parameters, are for a non-SBFD resource, and wherein a second set of transmission parameters, of the more than two transmission parameters, are for an SBFD resource.
Aspect 36: The method of any of Aspects 24-35, further comprising transmitting a configuration of a plurality of sounding reference signal resource (SRS) resource sets, wherein receiving the communication further comprises receiving the communication in an SBFD resource using a first subset of the plurality of SRS resource sets, and wherein the method further comprises receiving another communication in a non-SBFD resource, in accordance with the mTRP transmission scheme, using a second subset of the plurality of SRS resource sets.
Aspect 37: The method of Aspect 36, where the first subset and the second subset are a same subset.
Aspect 38: The method of Aspect 36, wherein the first subset is different from the second subset with regard to at least one SRS resource set of the plurality of SRS resource sets.
Aspect 39: The method of any of Aspects 24-38, wherein receiving the communication in accordance with the mTRP transmission scheme further comprises receiving the communication on an SBFD resource using a first beam pattern configuration and a non-SBFD resource using a second beam pattern configuration different than the first beam pattern configuration.
Aspect 40: The method of any of Aspects 24-39, wherein receiving the communication in accordance with the mTRP transmission scheme further comprises receiving the communication on an SBFD resource and a non-SBFD resource using a same beam pattern configuration.
Aspect 41: The method of any of Aspects 24-40, further comprising receiving another communication on the at least one SBFD resource that is included in the first set of resources using a single TRP transmission scheme, wherein the other communication is associated with a sounding reference signal (SRS) resource set configured for transmission using the single TRP transmission scheme on the at least one SBFD resource.
Aspect 42: The method of any of Aspects 24-41, further comprising receiving another communication on the at least one SBFD resource that is included in the first set of resources using a single TRP transmission scheme, wherein the other communication is associated with a sounding reference signal (SRS) resource set configured for transmission using the mTRP transmission scheme on the at least one SBFD resource, and wherein the other communication uses a proper subset of SRS resources of the SRS resource set.
Aspect 43: The method of any of Aspects 24-42, further comprising transmitting a configuration of a beam pattern for transmission on the at least one SBFD resource using a single TRP transmission scheme, wherein the configuration is via at least one of: a transmission configuration indicator, or a sounding reference signal resource set indicator; and receiving another communication on the at least one SBFD resource using the single TRP transmission scheme in accordance with the configuration.
Aspect 44: The method of any of Aspects 24-43, further comprising receiving another communication on the at least one SBFD resource using a single TRP transmission scheme in accordance with a beam pattern for the mTRP transmission scheme, wherein the beam pattern is modified for the single TRP transmission scheme.
Aspect 45: The method of any of Aspects 24-44, wherein receiving the communication in accordance with the mTRP transmission scheme further comprises receiving the communication on an SBFD resource and a non-SBFD resource, wherein the communication includes channel state information multiplexed on a physical uplink shared channel.
Aspect 46: The method of any of Aspects 24-45, wherein receiving the communication in accordance with the mTRP transmission scheme further comprises receiving the communication on an SBFD resource and a non-SBFD resource, wherein a redundancy version pattern is reset at a boundary between the SBFD resource and the non-SBFD resource.
Aspect 47: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-46.
Aspect 48: An apparatus for wireless communication at a device, the apparatus comprising one or more memories and one or more processors coupled to the one or more memories, the one or more processors configured to cause the device to perform the method of one or more of Aspects 1-46.
Aspect 49: An apparatus for wireless communication, the apparatus comprising at least one means for performing the method of one or more of Aspects 1-46.
Aspect 50: A non-transitory computer-readable medium storing code for wireless communication, the code comprising instructions executable by one or more processors to perform the method of one or more of Aspects 1-46.
Aspect 51: A non-transitory computer-readable medium storing a set of instructions for wireless communication, the set of instructions comprising one or more instructions that, when executed by one or more processors of a device, cause the device to perform the method of one or more of Aspects 1-46.
Aspect 52: A device for wireless communication, the device comprising a processing system that includes one or more processors and one or more memories coupled with the one or more processors, the processing system configured to cause the device to perform the method of one or more of Aspects 1-46.
Aspect 53: An apparatus for wireless communication at a device, the apparatus comprising one or more memories and one or more processors coupled to the one or more memories, the one or more processors individually or collectively configured to cause the device to perform the method of one or more of Aspects 1-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a configuration of an uplink multiple transmission reception point (TRP) (mTRP) transmission scheme for a first set of resources;
receive an indication of a sub-band full duplex (SBFD) configuration relating to a second set of resources, the first set of resources including at least one resource of the second set of resources, wherein the at least one resource is at least one SBFD resource; and
transmit a communication in accordance with the uplink mTRP transmission scheme on a subset of resources of the first set of resources, the subset of resources being derived from the SBFD configuration.

2. The apparatus of claim 1, wherein the subset of resources includes only non-SBFD resources of the first set of resources.

3. The apparatus of claim 2, wherein at least one processor of the one or more processors is configured to cause the UE to transmit on the at least one SBFD resource that is included in the first set of resources using a single transmission reception point transmission scheme.

4. The apparatus of claim 1, wherein the subset of resources includes the at least one SBFD resource.

5. The apparatus of claim 4, wherein, to cause the UE to transmit the communication in accordance with the uplink mTRP transmission scheme on the subset of resources, at least one processor of the one or more processors is configured to cause the UE to transmit the communication using a first transmission parameter on a non-SBFD resource of the subset of resources and transmitting the communication using a second transmission parameter on the at least one SBFD resource.

6. The apparatus of claim 1, wherein at least one processor of the one or more processors is configured to cause the UE to receive information indicating whether transmission using the uplink mTRP transmission scheme on SBFD resources is enabled, wherein, to cause the UE to transmit the communication in accordance with the mTRP transmission scheme, at least one processor of the one or more processors is configured to cause the UE to transmit the communication in accordance with the information.

7. The apparatus of claim 1, wherein the communication is a physical uplink control channel (PUCCH) communication, and
wherein at least one processor of the one or more processors is configured to cause the UE to receive dynamic signaling indicating a plurality of transmission parameters for the PUCCH communication, wherein the plurality of transmission parameters include more than two transmission parameters.

8. The apparatus of claim 1, wherein at least one processor of the one or more processors is configured to cause the UE to receive a configuration of a plurality of sounding reference signal resource (SRS) resource sets, wherein, to cause the UE to transmit the communication, at least one processor of the one or more processors is configured to cause the UE to transmit the communication in the at least one SBFD resource using a first subset of the plurality of SRS resource sets, and
wherein at least one processor of the one or more processors is configured to cause the UE to transmit another communication in a non-SBFD resource, in accordance with the mTRP transmission scheme, using a second subset of the plurality of SRS resource sets.

9. The apparatus of claim 1, wherein, to cause the UE to transmit the communication in accordance with the uplink mTRP transmission scheme, at least one processor of the one or more processors is configured to cause the UE to transmit the communication on the at least one SBFD resource using a first beam pattern configuration and a non-SBFD resource using a second beam pattern configuration different than the first beam pattern configuration.

10. The apparatus of claim 1, wherein, to cause the UE to transmit the communication in accordance with the uplink mTRP transmission scheme, at least one processor of the one or more processors is configured to cause the UE to transmit the communication on the at least one SBFD resource and a non-SBFD resource using a same beam pattern configuration.

11. The apparatus of claim 1, wherein at least one processor of the one or more processors is configured to cause the UE to transmit another communication on the at least one SBFD resource that is included in the first set of resources using a single TRP transmission scheme, wherein the other communication is associated with a sounding reference signal (SRS) resource set configured for transmission using the single TRP transmission scheme on the at least one SBFD resource.

12. The apparatus of claim 1, wherein at least one processor of the one or more processors is configured to cause the UE to transmit another communication on the at least one SBFD resource that is included in the first set of resources using a single TRP transmission scheme, wherein the other communication is associated with a sounding reference signal (SRS) resource set configured for transmission using the uplink mTRP transmission scheme on the at least one SBFD resource, and wherein the other communication uses a proper subset of SRS resources of the SRS resource set.

13. An apparatus for wireless communication at a network node, comprising:
one or more memories storing processor-executable code; and
one or more processors coupled with the one or more memories, at least one processor of the one or more processors configured to cause the network node to:
transmit a configuration of an uplink multiple transmission reception point (TRP) (mTRP) transmission scheme for a first set of resources;
transmit an indication of a sub-band full duplex (SBFD) configuration relating to a second set of resources, the first set of resources including at least one resource of the second set of resources, wherein the at least one resource is at least one SBFD resource; and
receive a communication in accordance with the uplink mTRP transmission scheme on a subset of resources of the first set of resources, the subset of resources being derived from the SBFD configuration.

14. The apparatus of claim 13, wherein the subset of resources includes only non-SBFD resources of the first set of resources.

15. The apparatus of claim 14, wherein at least one processor of the one or more processors is configured to cause the network node to receive on the at least one SBFD resource that is included in the first set of resources using a single transmission reception point transmission scheme.

16. The apparatus of claim 13, wherein the subset of resources includes the at least one SBFD resource.

17. The apparatus of claim 16, wherein, to cause the network node to receive the communication in accordance with the uplink mTRP transmission scheme on the subset of resources, at least one processor of the one or more processors is configured to cause the network node to receive the communication using a first transmission parameter on a non-SBFD resource of the subset of resources and receiving the communication using a second transmission parameter on the at least one SBFD resource.

18. The apparatus of claim 13, wherein at least one processor of the one or more processors is configured to cause the network node to transmit information indicating whether transmission using the uplink mTRP transmission scheme on SBFD resources is enabled,
wherein, to cause the network node to receive the communication in accordance with the uplink mTRP transmission scheme, at least one processor of the one or more processors is configured to cause the network node to receive the communication in accordance with the information, wherein the information indicating whether transmission using the uplink mTRP transmission scheme on SBFD resources is enabled comprises at least one of:
a configuration of a number of transmission configuration indicator (TCI) states, or
a configuration of a number of sounding reference signal resource sets.

19. The apparatus of claim 13, wherein at least one processor of the one or more processors is configured to cause the network node to receive another communication on the at least one SBFD resource that is included in the first set of resources using a single TRP transmission scheme, wherein the other communication is associated with a sounding reference signal (SRS) resource set configured for transmission using the single TRP transmission scheme on the at least one SBFD resource.

20. The apparatus of claim 13, wherein at least one processor of the one or more processors is configured to cause the network node to receive another communication on the at least one SBFD resource that is included in the first set of resources using a single TRP transmission scheme, wherein the other communication is associated with a sounding reference signal (SRS) resource set configured for transmission using the uplink mTRP transmission scheme on the at least one SBFD resource, and wherein the other communication uses a proper subset of SRS resources of the SRS resource set.

21. The apparatus of claim 13, wherein at least one processor of the one or more processors is configured to cause the network node to receive another communication on the at least one SBFD resource using a single TRP transmission scheme in accordance with a beam pattern for the uplink mTRP transmission scheme, wherein the beam pattern is modified for the single TRP transmission scheme.

22. A method of wireless communication performed at a user equipment (UE), comprising:
receiving a configuration of an uplink multiple transmission reception point (TRP) (mTRP) transmission scheme for a first set of resources;
receiving an indication of a sub-band full duplex (SBFD) configuration relating to a second set of resources, the first set of resources including at least one resource of the second set of resources, wherein the at least one resource is at least one SBFD resource; and
transmitting a communication in accordance with the uplink mTRP transmission scheme on a subset of resources of the first set of resources, the subset of resources being derived from the SBFD configuration.

23. The method of claim 22, further comprising transmitting another communication on the at least one SBFD resource that is included in the first set of resources using a single TRP transmission scheme, wherein the other communication is associated with a sounding reference signal (SRS) resource set configured for transmission using the uplink mTRP transmission scheme on the at least one SBFD resource, and wherein the other communication uses a proper subset of SRS resources of the SRS resource set.

24. The method of claim 22, further comprising receiving a configuration of a beam pattern for transmission on the at least one SBFD resource using a single TRP transmission scheme, wherein the configuration is via at least one of:
a transmission configuration indicator, or
a sounding reference signal resource set indicator; and
transmitting another communication on the at least one SBFD resource using the single TRP transmission scheme in accordance with the configuration.

25. The method of claim 22, further comprising transmitting another communication on the at least one SBFD resource using a single TRP transmission scheme in accordance with a beam pattern for the uplink mTRP transmission scheme, wherein the beam pattern is modified for the single TRP transmission scheme.

26. The method of claim 22, wherein transmitting the communication in accordance with the uplink mTRP transmission scheme further comprises transmitting the communication on the at least one SBFD resource and a non-SBFD resource, wherein the communication includes channel state information multiplexed on a physical uplink shared channel.

27. The method of claim 22, wherein transmitting the communication in accordance with the uplink mTRP transmission scheme further comprises transmitting the communication on the at least one SBFD resource and a non-SBFD resource, wherein a redundancy version pattern is reset at a boundary between the at least one SBFD resource and the non-SBFD resource.

28. A method of wireless communication performed at a network node, comprising:
transmitting a configuration of an uplink multiple transmission reception point (TRP) (mTRP) transmission scheme for a first set of resources;
transmitting an indication of a sub-band full duplex (SBFD) configuration relating to a second set of resources, the first set of resources including at least one resource of the second set of resources, wherein the at least one resource is at least one SBFD resource; and
receiving a communication in accordance with the uplink mTRP transmission scheme on a subset of resources of the first set of resources, the subset of resources being derived from the SBFD configuration.

29. The method of claim 28, wherein the communication is a physical uplink control channel (PUCCH) communication, and
wherein the method further comprises transmitting dynamic signaling indicating a plurality of transmission parameters for the PUCCH communication, wherein the plurality of transmission parameters include more than two transmission parameters.

30. The method of claim 29, wherein a first set of transmission parameters, of the more than two transmission parameters, are for a non-SBFD resource, and wherein a second set of transmission parameters, of the more than two transmission parameters, are for the at least one SBFD resource.
